(19) United States
(12) Patent Application Publication
(10) Pub. No.: US 2026/0031924 A1
(43) Pub. Date: Jan. 29, 2026

(54) GAIN COMPENSATED OPTICAL SPLITTER

(71) Applicant: AT&T Intellectual Property I, L.P., Atlanta, GA (US)

(72) Inventors: Ricky Perry, Cumming, GA (US); Stewart Barker, Lucas, TX (US)

(73) Assignee: AT&T Intellectual Property I, L.P., Atlanta, GA (US)

(21) Appl. No.: 18/781,409

(22) Filed: Jul. 23, 2024

(51) Int. Cl. H04J 14/02; H01S 3/067; H04Q 11/00

(52) U.S. Cl. CPC H04J 14/0221; H01S 3/06754; H04J 14/0282; H04Q 11/0067

(57) ABSTRACT

Aspects of the subject disclosure may include, for example, an optical signal distribution device including an optical amplifier and an optical power divider. The optical amplifier may be configured to apply an optical signal gain that amplifies a downstream optical signal operating at a first optical power level to a second, increased optical power level. The optical power divider includes a first optical port and a group of second optical ports, in which the first optical port is optically coupled to the optical amplifier. The optical power divider is configured to apply a power division process to the amplified downstream signal to obtain a group of divided optical signals that may be provided to the group of second optical ports. The resulting optical signal levels of the group of divided optical signals are reduced from the second, increased optical power level according to the power division. Other embodiments are disclosed.

### FIELD OF THE DISCLOSURE

The subject disclosure relates to a gain compensated optical splitter.

### BACKGROUND

In an optical network, a signal may be transmitted over an optical fiber. The signal may include a plurality of channels. A power splitter may divide a channel into a plurality of distinct outputs. A signal, containing a single channel or multiple channels, may be divided by a splitter and delivered to several different destinations.

Currently, there is particular demand for optical splitter devices for use in fiber-to-the-curb (FTTC) and fiber-to-the-home (FTIB) communication networks. These splitter devices facilitate the distribution of a common signal to multiple customers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2 is a block diagram illustrating an example, non-limiting embodiment of an optical access network functioning within the communication network of FIG. 1 in accordance with various aspects described herein.

FIG. 3 is a block diagram illustrating an example, non-limiting embodiment of an amplified optical power splitter/combiner device functioning within the communication network of FIG. 1 in accordance with various aspects described herein.

FIG. 4 is a block diagram illustrating an example, non-limiting embodiment of another amplified optical power splitter/combiner device functioning within the communication network of FIG. 1 in accordance with various aspects described herein.

FIG. 5 is a block diagram illustrating an example, non-limiting embodiment of another amplified optical power splitter/combiner device functioning within the communication network of FIG. 1 in accordance with various aspects described herein.

FIG. 6 is a block diagram illustrating an example, non-limiting embodiment of yet another amplified optical power splitter/combiner device functioning within the communication network of FIG. 1 in accordance with various aspects described herein.

FIG. 7 depicts an illustrative embodiment of a gain-compensated optical signal distribution process in accordance with various aspects described herein.

FIG. 8 depicts an illustrative embodiment of another gain-compensated optical signal distribution process in accordance with various aspects described herein.

FIG. 9 is a block diagram of an example, non-limiting embodiment of a computing environment in accordance with various aspects described herein.

### DETAILED DESCRIPTION

The subject disclosure describes, among other things, illustrative embodiments for a gain-compensated optical splitter that provides optical signal gain in combination with optical power division so as to reduce and/or otherwise eliminate signal loss attributable to optical power division.

One or more aspects of the subject disclosure include an optical signal distribution device. The optical signal distribution device includes an optical amplifier configured to apply an optical signal gain adapted to amplify a downstream optical signal operating at a first optical power level according to the optical signal gain to obtain an amplified downstream signal. The amplified downstream signal operates at a second, increased optical power level. The optical signal distribution device also includes an optical power divider that includes a first optical port and a number of second optical ports. The first optical port is optically coupled to the optical amplifier, wherein the optical power divider is configured to apply a power division the amplified downstream signal to obtain a number of divided optical signals provided to the number of second optical ports. The resulting optical signal levels of the multiple divided optical signals are reduced from the second, increased optical power level according to the power division.

One or more aspects of the subject disclosure include an optical signal distribution process that includes receiving a downstream optical signal to obtain a received downstream optical signal having a first optical power level. According to the process, the received downstream optical signal is amplified according to an optical signal gain value to obtain an amplified downstream optical signal. The amplified downstream optical signal is divided according to an optical power division process to obtain a number of divided downstream optical signals, wherein the number of divided downstream optical signals operate according to a number of second optical power levels determined at least in part according to the optical power division process.

One or more aspects of the subject disclosure include a non-transitory, machine-readable medium, that includes executable instructions that, when executed by a processing system including a processor, facilitate performance of operations. The operations include identifying an optical power division process and calculating an insertion loss according to the optical power division process. The operations further include determining an optical signal gain value responsive to the insertion loss and applying an optical signal gain according to the optical signal gain value. The optical signal gain is applied to a downstream optical signal received at a received power level to obtain a gain adjusted downstream optical signal. A division of the gain adjusted downstream optical signal yields a divided optical signal having an output optical power level approximating the received power level.

A conventional optical signal splitter introduces an insertion loss according to a power division of an input optical signal. Accordingly, a 1×2 splitter introduces 3 dB of insertion loss, a 1×16 splitter introduces 12 dB of insertion loss and so on. In at least some embodiments, the optical signal splitter may introduce an excess insertion loss due to other factors, such as connector loss, internal reflections, signal absorption, heating, and the like. It may be appreciated that insertion loss of an optical signal splitter may severely limit a transmission link length as the number of customers increases due to the natural signal loss associated with every splitting function. The illustrative devices, systems, processes and computer readable media disclosed herein provide low loss optical splitter and optical splitter/combiner combinations. In at least some embodiments, losses attributable to signal splitting may be managed and/or otherwise compensated to provide a substantially loss-neutral optical splitting and/or splitting/combining device. It is envisioned that in at least some embodiments, the low loss and/or loss-neutral optical splitting and/or splitting/combining devices may be operable in a passive manner, e.g., without requiring power other than the optical signals processed by the splitter and/or splitter/combiner. In at least some embodiments, an offset and/or compensation for the insertion loss may be provided, e.g., by introducing an optical signal gain function together with the signal splitting function within a single device. At least some of the examples disclosed herein provide passive gain-compensated splitters that are particularly well suited for passive optical network (PON) architectures.

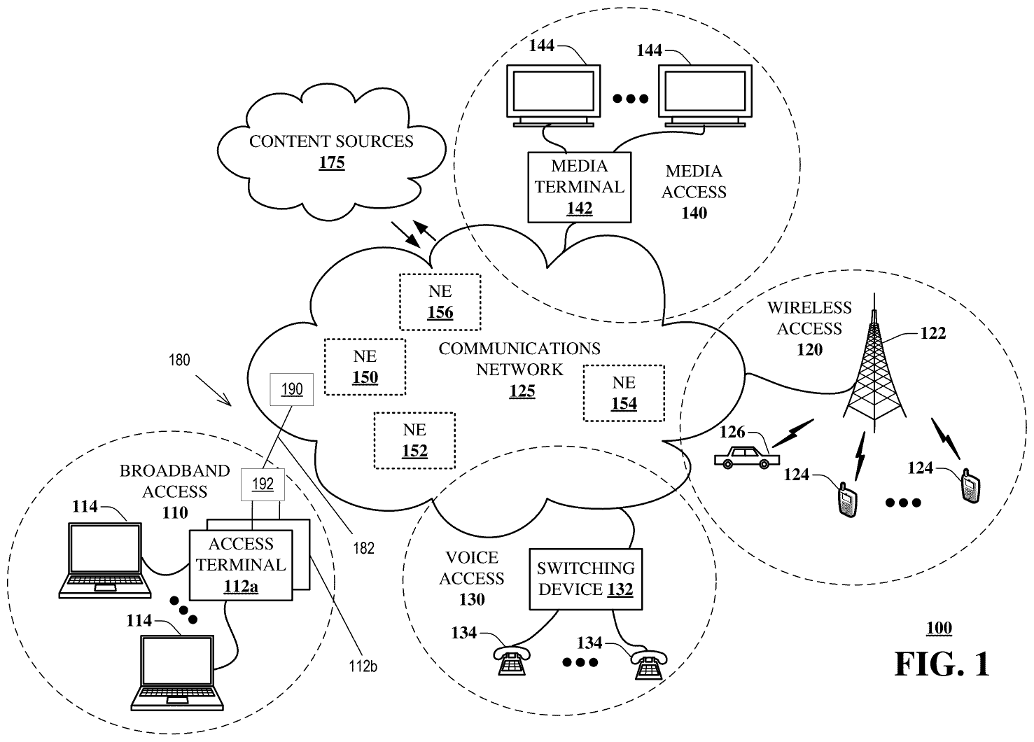

Referring now to FIG. 1, a block diagram is shown illustrating an example, non-limiting embodiment of a communication network 100 in accordance with various aspects described herein. For example, the communication network 100 can facilitate in whole or in part delivery of network services, such as broadband Internet access to the home and/or business via optical fiber distribution networks. In at least some configurations, these networks include passive optical networks (PONs) that provide an efficient means for signal transport and distribution. For example, a PON may be provided between a single network provider device, e.g., at an optical line terminal (OLT) at a headend of a network or at some other convenient network distribution node, and multiple end-user devices, such as optical network terminals (ONTs) at subscriber premises. It is common for such PON distribution networks to include optical power splitters and/or combiners to manage optical signal distribution to ensure reliable network services.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets, or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway, or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communication network 100 includes an optical network 180 extending network access and/or network accessible services to multiple access locations. For example, the optical network provides an optical communication channel, e.g., an optical fiber 182 between an upstream device, e.g., an optical line terminal (OLT) 190 and a group of access terminals 112a, 112b, generally 112. In more detail, the optical network 180 includes an amplified splitter/combiner system 192 coupled between the ONT and the access terminals 112, e.g., optical network terminals (ONT). The amplified splitter/combiner system 192 may be configured to amplify a downstream signal directed from the OLT 190 to the ONT 112, and to divide the amplified downstream signal as may be required according to a particular number of ONT 112. In at least some embodiments, the amplification is applied to at least partially, if not completely compensate for insertion loss resulting from the optical signal division. It is further understood that the optical network 180 may operate in a downstream direction, an upstream direction, e.g., from the ONT 112 to the OLT 190 and/or a combination of upstream and downstream directions.

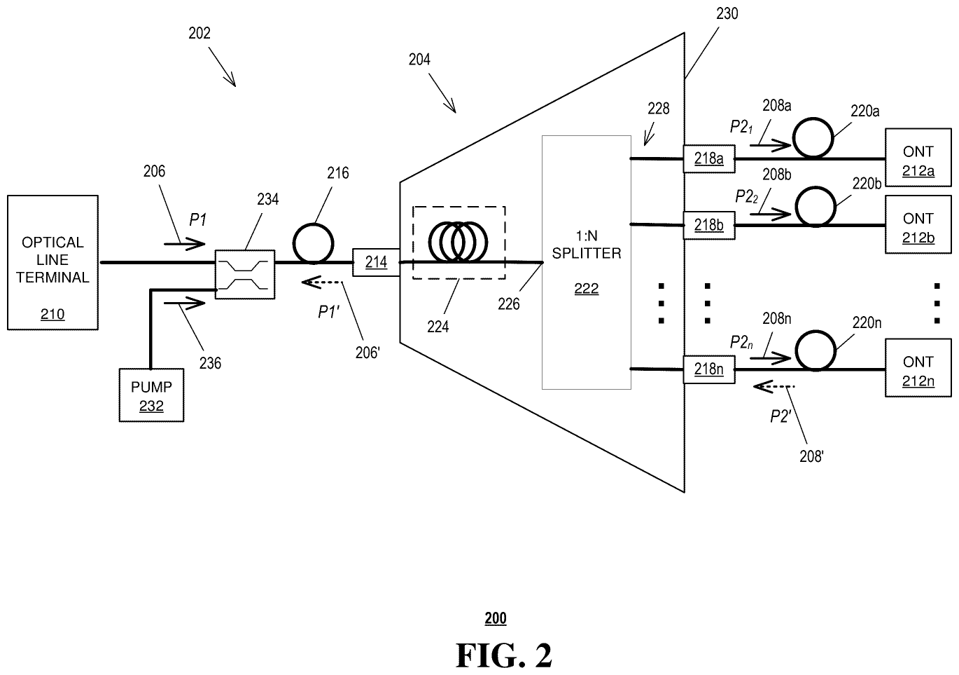

FIG. 2 is a block diagram illustrating an example, non-limiting embodiment of an optical signal distribution system 200 functioning within the communication network 100 of FIG. 1 in accordance with various aspects described herein. The example optical signal distribution system 200 exchanges one or more optical signals over an optical fiber network 202. Without limitation, the optical fiber network 202 may include a passive optical network (PON), such as EPON, GPON, BPON, FTTX, FTTH, and the like. The optical signal(s), in turn, may include one or more channels, e.g., distinguishable by one or more of time frequency, wavelength and/or encoding. To this end, the example optical signal distribution system 200 includes at least one amplified optical power splitting device 204 configured to divide and/or otherwise split at least one optical input signal 206 into multiple optical output signals, e.g., split and/or divided downstream optical output signals 208a, 208b . . . 208n, generally 208. For example, the optical input signal 206 may have a first optical signal power level P1, which may be split and/or divided into the multiple distinct downstream optical output signals 208 having respective optical signal power levels P2₁, P2₂ . . . P2ₙ. Without limitation, at least some of the power levels P1 and P2₁, P2₂ . . . P2ₙ may be substantially similar to and/or different from other ones of the power levels.

By way of example, the optical signal distribution system 200 includes at least one optical line terminal (OLT) 210 configured to generate and/or otherwise provide, e.g., injection the optical input signal 206 into the optical fiber network 202. The amplified optical power splitting device 204 divides the optical input signal 206 into the multiple downstream optical output signals 208 that may be delivered to one or more different destinations. According to the illustrative example, the different destinations include optical network terminals (ONTs) 212a, 212b . . . 212n, generally 212, as may be employed in fiber-to-the-curb (FTTC) and/or fiber-to-the-home (FTTH) applications. In at least some embodiments, the amplified optical power splitting device 204 facilitates distribution of a common signal, e.g., the optical input signal 206, to multiple customers, e.g., via the ONTs 212 located at customer premises.

In one embodiment, the OLT 210 transmits the optical input signal 206 via the optical fiber network 202 to provide subscriber information to the end-users or subscribers, such as content and/or network services. It is understood that according to such applications the OLT 210 may be configured to transmit a common optical channel, one or more independent optical channels and/or any combination thereof, e.g., to each subscriber and/or differentiated groups of subscribers via on-premises equipment, such as the example ONTs 212. In this manner, the OLT 210 may provide subscribers with any combination of broadcast, multicast, and/or dynamically allocated voice, data, and/or video bandwidth.

In at least some embodiments, the amplified optical power splitting device 204 has a housing input terminal 214 coupled to one end of a proximal optical fiber segment 216. Another end of the proximal optical fiber segment 216 may be coupled to and/or otherwise in optical communication with the OLT 210. According to the illustrative embodiments, the amplified optical power splitting device 204 has multiple housing output terminals 218a, 218b . . . 218n, generally 218. The housing output terminals 218 are respectively coupled to first ends of a group of distal optical fiber segments 220a, 220b . . . 220n, generally 220. The group of distal optical fiber segment 220 have second ends that are respectively coupled to and/or otherwise in optical communication with the ONTs 212.

In at least some embodiments, the amplified optical power splitting device 204 includes at least one optical power splitter 222, at least one optical amplifier 224, and a housing 230 configured to contain the example optical power splitter 222 and the example optical amplifier 224. In at least some embodiments, the optical power splitter 222 may be configured according to a power division ratio, e.g., a ratio of 1×N, in which an input optical signal having an input power level Pᵢₙ may be equally divided into N separate optical output signals, each having an output optical signal power level Pout determined according to the power division ratio, e.g., Pₒᵤₜ=Pᵢₙ/N. The example optical power splitter 222 includes an input terminal 226 and a group of output terminals 228, configured such that each output terminal provides a respective optical output signal determined according to the power division ratio. According to the illustrative embodiment, the optical amplifier 224 is optically coupled between the housing input terminal 214 and the input terminal 226 of the optical power splitter 222. Likewise, the group of ONTs 212 of the optical power splitter 222 are respectively coupled to the multiple housing output terminals 218.

According to the illustrative embodiment, the optical amplifier 224 applies gain to the optical input signal 206. For example, the optical amplifier 224 applies a gain value G to the optical input signal 206 having a corresponding optical power level P1. Accordingly, an optical input power Pᵢₙ at the input terminal 226 of the optical power splitter 222 may be determined according to the value Pᵢₙ=G·P1. According to the example power division ratio of 1×N, an optical output power level Pₒᵤₜ of each of the downstream optical output signals 208 may be determined according to the expression

$${P}_{out} = \frac{G \cdot {P}_{i n}}{N} .$$

Although a uniform optical power splitter 222 is disclosed, it is understood that in other embodiments, the optical power splitter 222 may be configured according to other split ratios, including non-uniform power splitting ratios. Balanced splitters may include at least one input waveguide and/or fiber and some number N output fibers that divide the power of the optical signal proportionally. Wave splitting involves dividing a light beam into multiple streams. The daughter streams can be equal or in some other ratio. For example, the optical power splitter 222 may be configured to provide a first group of optical output signals, each having a respective optical power P_{out_1}. Likewise, the optical power splitter 222 may be configured to provide a second group of optical output signals, each having a second total optical power P_{out_2}, such that P_{out_1}≠P_{out_2}. For example, consider that each group has a different number of optical output signals, i.e., the first group includes N optical output signals, whereas the second group includes M optical output signals, such that M≠N. To the extent that the first and second groups share optical power equally, P_{out_1} may be determined according to equation 1, whereas P_{out_2} may be determined according to equation 2:

$${P}_{{out}_{-} 1} = G \cdot {P}_{i n} \cdot \frac{1}{2 N} \qquad ( Eq . 1 )$$

$${P}_{{out}_{-} 2} = G \cdot {P}_{i n} \cdot \frac{1}{2 M} \qquad ( Eq . 2 )$$

Likewise, although a single optical power splitter 222 and a single optical amplifier 224 are illustrated in the example amplified optical power splitting device 204, it is understood that other configurations may include one or more optical power splitters 222 and one or more amplified optical power splitting device 204 arranged and/or otherwise interconnected in various configurations. For example, other arrangements of optical power splitters may be arranged in stages, such that an output of one power splitter, i.e., of a first splitter stage, is coupled to an input of another power splitter, e.g., of a second splitter stage. Alternatively, or in addition, in some embodiments, the optical signal gain may be contained entirely before a first stage of a multi-stage optical power splitter distributed, whereas, in other embodiments, at least a portion of the optical signal gain may be applied between different splitter stages.

In at least some embodiments, the optical power splitter 222 may include at least one fused biconical taper (FBT) splitter. Alternatively, or in addition, the optical power splitter 222 may include at least one planar lightwave circuit (PLC) splitters. It is understood that FBT splitters use two or more fibers, in which the fibers' coating layers are removed and the fibers may be stretched at the same time under a heating zone to form a signal splitting region, e.g., a double cone structure. The resulting fused waveguide structure may allow for control of a resulting splitting ratio, e.g., via controlling one or more of a length of the fiber torsion angle and/or an applied stretch. The PLC splitter may be configured as a a micro-optical element, e.g., using photolithographic techniques to form optical waveguide at a medium layer and/or semiconductor substrate to realize a power splitting, or branch distribution function. For example, in at least some embodiments, graded-index silica-glass waveguides may be used to fabricate PLC optical splitters, allowing a resulting splitting ratio to be adjusted during the design and fabrication phases.

In at least some embodiments, the optical amplifier 224 is configured to amplify an input optical signal directly, without the need to first convert it to an electrical signal. In some embodiments, the optical amplifier 224 may include an active device, such as a semiconductor optical amplifier (SOA). For example, a gain medium, such as a semiconductor, e.g., a group III-V compound semiconductor such as GaAs, as may be used in a laser but without a resonant cavity. In at least some embodiments, this configuration may utilize antireflective coatings. The semiconductor gain medium may be excited or stimulated, e.g., pumped, to produce gain for an optical signal. Alternatively, or in addition, the optical amplifier 224 may include a passive optical amplifier, such as a treated or doped optical transport medium, such as an optical fiber. Doped optical fibers, sometimes referred to as active fibers may contain single mode, multi-mode and/or polarization maintaining optical fibers whose fiber cores are treated or doped with another material, e.g., laser-active ions. In at least some embodiments, an treated, doped or active fiber segment may be doped with a rare earth element, such as Erbium (Er), e.g., Erbium doped fiber amplifier (EDFA). In at least some embodiments, EDFAs may be optimized for an operational bandwidth, e.g., between about 1512 nm and about 1570 nm. In operation, the EDFA may be pumped at a one wavelength, e.g., a relatively short wavelength around 980 nm and/or around 1480 nm to facilitate amplification or gain to signals operating at another wavelength, e.g., at a relatively long wavelength, such as a C-band wavelength from around 1525-1565 nm and/or an L-band wavelength from around 1570-1610 nm. Other doping materials may include, without limitation, Thulium, Phosphorous, Bismuth, Germanium, Prascodymium, and/or Ytterbium, alone or in any combination, each offering different respective operational wavelengths. In general, a treated, doped or active fiber segment may include any rare earth element.

It is understood that optical amplifiers may be pumped by a local source, e.g., proximate to the amplified optical power splitting device 204 and in at least some instances, within the housing 230. Alternatively, or in addition, an optical amplifier may be pumped from a remote source, e.g., separated from the amplified optical power splitting device 204 by at least the example proximal optical fiber segment 216. Beneficially, in such remote pumping configurations, the amplified optical power splitting device 204 may be configured as a passive device, e.g., not requiring a separate power source, such as a local optical source and/or an electrical power source. In at least some embodiments, an optical amplifier may include one or more other devices, such as optical isolators, optical splitters or taps, optical detectors, optical filters, e.g., gain flattening filters, and the like. For example, an optical splitter or tap may direct a portion of an optical input signal to an optical detector to obtain an indication of an input signal level or power. Likewise, an optical splitter or tap may direct a portion of an optical output signal to an optical detector to obtain an indication of an amplified output signal level or power. Detected input and/or output signal or power levels may be used by a control device, such as an active gain controller. For example, an active gain controller may be configured to control a pump level, which may be used to adjust an optical amplifier gain level. Other components, such as a signal combiner may be used to combine an optical pumping source with an input optical signal at an input of a treated, doped or active fiber segment. In at least some embodiments, a gain flattening filter may be provided, e.g., at an output of the treated, doped or active fiber segment and, in at least some embodiments, one or more optical isolators may be provided to isolate an input and/or an output of the optical amplifier.

In at least some embodiments, a treated, doped and/or otherwise active fiber segment, e.g., an EDF, may be disaggregated and integrated into an optical splitter and/or splitter/combiner. For example, transmission of certain optical single wavelengths, e.g., 1550 nm wavelengths, will reduce or eliminate splitter loss which is a critical portion of the optical loss budget. The example 1550 signal is amplified through the interaction with the doping Erbium ions. This action amplified a weak optical signal to a higher power, effecting a boost in the signal strength prior to splitting. Through control of a gain, e.g., a pump level, the gain may be adjusted in relation to the losses, e.g., the splitter losses, to provide an overall gain profile having a relatively low loss, and in at least some configurations, a net zero loss.

According to the illustrative example, the optical amplifier 224 is a passive optical amplifier including an EDFA. A remote optical excitation source, e.g., a remote pump 232, may be coupled to the proximal optical fiber segment 216 via an optical coupling device 234. For example, the remote pump 232 provides an optical signal at a relatively short wavelength that is coupled to the proximal optical fiber segment 216 vial the optical coupling device 234 to obtain a coupled pump signal, referred to herein as a co-propagating pump signal 236. The co-propagating pump signal 236 at a relatively short wavelength is propagated together with the optical input signal 206 obtained from the optical line terminal (OLT) 210 and operating at a relatively long wavelength. The co-propagating pump signal 236 is directed to the optical amplifier 224, e.g., the EDFA, and provides a suitable excitation to induce an amplification or gain to the co-propagating optical input signal 206.

In at least some embodiments of the amplified optical power splitting device 204, the optical power splitter 222 includes a splitter section and the optical amplifier 224 includes a waveguide amplifier section that may be integrated in a single device within the housing 230. The optical input signal 206 having the first power level P1 is amplified according to the optical power signal to obtain an amplified signal G·P1 signal that is applied to the input terminal 226 of the optical power splitter 222 where, in this example, it is split into N identical optical output signals, sometimes revered to as downstream optical output signals 208, each having an optical power level G·P1/N. It is understood that the application of gain prior to signal splitting or division may be applied in such a manner so as to obtain an optical output signal having a preferred optical power level. For example, the gain value G applied by the optical amplifier 224 may be determined at least in part according to the number of outputs, N. Consider at least one configuration in which G is determined to offset the signal splitter loss, i.e., G≈N. Accordingly, each output signal will have an output signal power level P2 that approximates the original optical input signal power level P1, i.e., P2≈P1. Other values of G may be determined according to the split ratio, e.g., providing an optical output signal power level that differs from the optical input signal power level according to a predetermined and/or otherwise preferred ratio. In at least some embodiments, the gain value G is determined to exceed the signal splitter loss, i.e., G>N.

In at least some embodiments, the optical amplifier 224 and/or the optical power splitter 222 may be fabricated using a monolithic integration approach with at least both the optical power splitter 222 and the optical amplifier 224, fabricated on a single planar waveguide optical chip. Alternatively, e.g., according to a hybrid approach, the optical power splitter 222 and the optical amplifier 224 may be fabricated in separate chips and then directly attached in a multi-chip module format that may be contained within the housing 230. In still another alternative embodiment, a fiber integration approach may be used in which the f optical power splitter 222 and the optical amplifier 224 are fabricated and packaged separately and then interconnected by way of optical fibers within the housing 230. In at least some embodiments, the optical power splitter 222 and the optical amplifier 224 may be provided in respective packages and/or housings that may be joined and/or otherwise interconnected, e.g., by an optical waveguide, by an optical fiber, by an optical connector, by a fiber tether and/or any combination thereof.

The examples discussed thus far refer to operation of the amplified power splitting device 204 in a first direction in which an optical input signal 206, e.g., directed from the OLT 210 to the ONTs 212, is first amplified and then then split into multiple downstream optical output signals 208. Alternatively, or in addition, the amplified power splitting device 204 may be operated in a second direction, in which return signals, e.g., from the ONTs 212, are combined then amplified, then directed towards the OLT 210. According to the upstream direction, the optical power splitter 222 may be referred to as an optical power combiner 222, or more generally as an optical splitter/combiner 222. For example, it is understood that in at least some embodiments, one or more subscribers may generate content and/or otherwise communicate with other remote entities, such as the network service provider, e.g., via on-premises equipment, such as the example ONTs 212 generating optical signals directed towards the OLT 210. Thus, it can be appreciated that the signal from a network services provider, e.g., from the OLT 210 at a “head end,” may be transmitted over the optical fiber network 202 in a “downlink” or “downstream” direction to subscriber equipment and as needed, desired channels can be split off using one or more splitter at locations where those signals are desired. Likewise, signals from the subscriber equipment, e.g., from one or more of the ONTs 212, may be transmitted toward the OLT 210 or head end over the optical fiber network 202 in an “uplink” or “upstream” direction. The same can be said for any of the various example embodiments disclosed herein, e.g., they may be operated in a downstream direction, in an upstream direction, or in a bidirectional mode in which both downstream and upstream signals are processed by the amplified power splitting devices.

According to the upstream configurations, optical input signals, i.e., upstream optical input signals 208′ generated at the ONTs 212 may have a first optical power level P2′. The upstream optical input signals 208′ from two or more of the ONTs 212 may be combined by the optical splitter 222 operating in a reverse direction in which upstream optical signals received on any one or more of the group of output terminals 228 of the optical signal splitter/combiner 222 are combined according to a power combination process within the signal splitter/combiner 222 to obtain a power combined optical signal presented at the input terminal 226 of the optical signal splitter/combiner 222. The power combined optical signal may then be passed through the optical amplifier 224 to obtain an upstream, amplified power combined optical signal, which may then be directed towards the OLT 210, e.g., via the proximal optical fiber segment 216. It is worth noting here that a direction of the optical pumping may remain as illustrated, i.e., from the OLT 210 direction, such that the pump signal propagates in one direction, while the amplified signal propagates in an alternate direction.

It is envisioned that in at least some embodiments, the same gain value may be applied to optical signals traveling in either direction, i.e., downstream and/or upstream. Alternatively, or in addition, different gain values may be applied to optical signals travelling in different directions, e.g., applying a first gain value G1 to downstream, divided optical signals, and a second gain value G2 to upstream combined optical signals. In some embodiments, G1>G2, while in other embodiments, G2>G1, while in still other embodiments, G1≈G2.

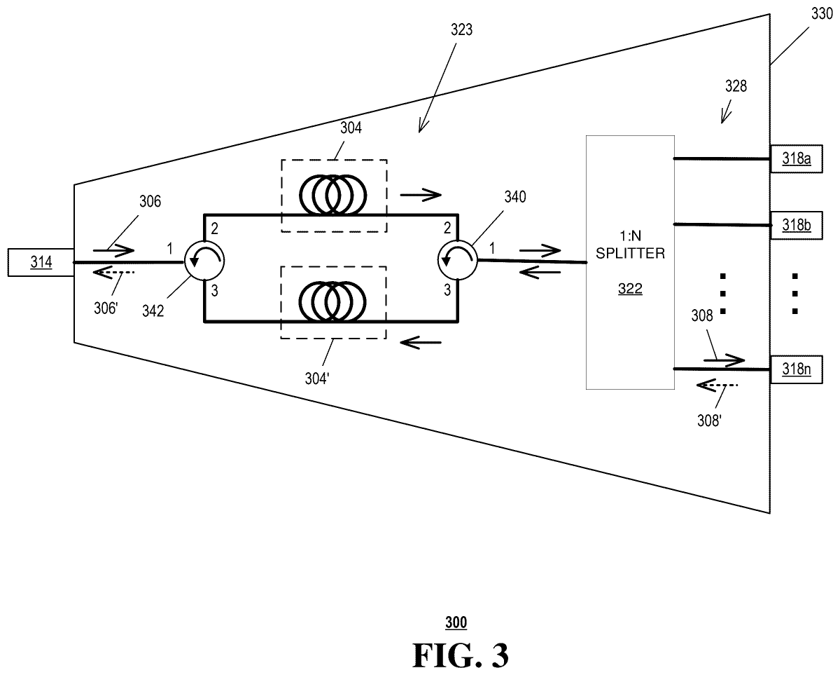

FIG. 3 is a block diagram illustrating an example, non-limiting embodiment of an amplified optical power splitter/combiner device 300 functioning within the communication network of FIG. 1 in accordance with various aspects described herein. The example amplified optical power splitter/combiner device 300 includes a housing 330 having at least one housing input terminal 314 and a group of housing output terminals 318a, 318b . . . 318n, generally 318. The housing input terminal 314 may be in optical communication with an upstream device, such as the example OLT 210 (FIG. 2). Similarly, the group of housing output terminals 318 may be in optical communication with a group of downstream devices, such as the example ONTs 212 (FIG. 2). The example housing 330 includes at least one optical signal splitter/combiner 322 and a directional amplifier 323. The optical signal splitter/combiner 322 has an upstream terminal optically coupled to the directional amplifier 323 and a group of downstream terminals 328 in communication with the group of housing output terminals 318. In operation, the amplified optical power splitter/combiner device 300 receives a downstream input optical signal 306 and amplifies that signal prior to dividing that signal among the group of output ports, with each port providing a respective downstream, divided optical signal 308. Conversely, the amplified optical power splitter/combiner device 300 receives one or more upstream optical signal 308′ and combines those signals prior to amplifying that signal.

According to the illustrative example, the directional amplifier 323 includes a first optical amplifier 304 selectively providing amplification to downstream optical signals and a second optical amplifier 304′ selectively providing amplification to upstream optical signals. According to the illustrative embodiment, the directional amplifier 323 includes a first directional coupler 342 coupled between each of the first and second optical amplifiers 304, 304′ and the housing input terminal 314. Likewise, the directional amplifier 323 includes a second directional coupler 340 coupled between each of the first and second optical amplifiers 304, 304′ and the optical signal splitter/combiner 322. The first and second directional couplers 340, 342 may include any suitable structure configured to independently route optical signals responsive to the direction of the optical signals. By way of example, the first and second directional couplers 340, 342 may include optical circulator devices configured to selectively couple optical signals to the first and second optical amplifiers 304, 304′ responsive to a direction of the optical signals.

It is understood that the first and second optical amplifiers 304, 304′ may include any of the example optical amplifiers disclosed herein, such as active devices, e.g., SOAs, passive devices, e.g., EDFA, and combinations thereof, e.g., using similar and/or different optical amplifiers in each of the forward and revers amplification paths. It is further understood that passive devices may be optically excited, stimulated and/or otherwise pumped by optical sources that may be internal and/or external to the housing 330. In at least some embodiments, the amplified optical power splitter/combiner device 300 may be configured as a passive device, e.g., suitable for deployment in a PON application, without requiring power and/or control signaling other than the downstream and/or upstream optical signals processed by the amplified optical power splitter/combiner device 300. It is also understood that the gain may be applied according to any of the various scenarios disclosed herein.

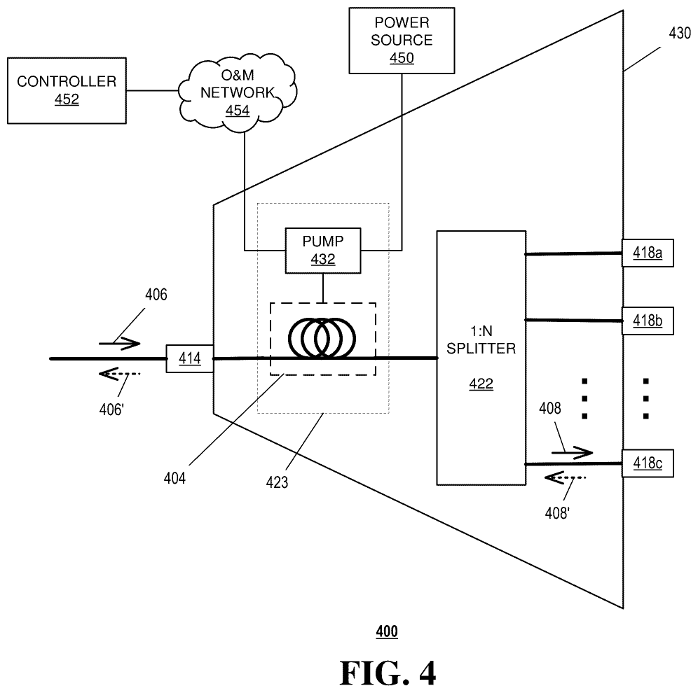

FIG. 4 is a block diagram illustrating an example, non-limiting embodiment of another amplified optical power splitter/combiner device 400 functioning within the communication network of FIG. 1 in accordance with various aspects described herein. The example amplified optical power splitter/combiner device 400 includes a housing 430 having at least one upstream housing terminal 414 and a group of downstream housing terminals 418a, 418b . . . 418n, generally 418. The upstream housing terminal 414 may be in optical communication with an upstream device, such as the example OLT 210 (FIG. 2). Similarly, the group of downstream housing terminals 418 may be in optical communication with a group of downstream devices, such as the example group of ONTs 212 (FIG. 2). In some embodiments, the amplified optical power splitter/combiner device 400 is configured to operate according to a downstream mode in which a downstream input optical signal 406, e.g., received from an OLT 210 is amplified and divided into multiple downstream optical output signals 408, e.g., directed towards multiple recipients, e.g., the example group of ONTs 212. Alternatively, or in addition, the amplified optical power splitter/combiner device 400 is configured to operate according to an upstream mode in which one or more upstream optical signals 408′, e.g., received from the example group of ONT 212 may be combined into a single upstream optical signals 406′, e.g., directed towards an upstream or headend device, e.g., the example OLT 210.

The example housing 430 includes at least one optical signal splitter/combiner 422 and an active optical amplifier 423. The optical signal splitter/combiner 422 has an upstream terminal optically coupled to the active optical amplifier 423 and a group of downstream terminals in communication with the group of downstream housing terminals 418. According to the downstream mode of operation, the amplified optical power splitter/combiner device 400 receives the downstream input optical signal 406 and amplifies that signal prior to dividing that signal among the group of output ports, with each port providing a respective divided, downstream optical output signal 408. Conversely, the amplified optical power splitter/combiner device 400 receives one or more upstream optical signal 408′ and combines those signals into an aggregate single upstream signal prior to amplifying that signal.

According to the illustrative example, the active optical amplifier 423 includes an optical amplifier, such as a gain medium, e.g., an EDFA 404. By way of example, the EDFA 404 may be excited, stimulated and/or otherwise pumped via a local optical pump 432. The optical pump may be powered by a power source 450 that may be line power, e.g., utility power and/or a local power supply, such as a transformer coupled to utility power, a battery, and/or a renewable power source, such as may be provided by a solar cell, a wind turbine, and the like.

In at least some embodiments, the active optical amplifier 423 may be controllable. For example, a controller 452 may be coupled to the active optical amplifier 423 and adapted to operate one or more operable parameters of the active optical amplifier 423. In at least some embodiments, the controller 452 may be coupled to the active optical amplifier 423 within the housing 430. Alternatively, the controller 452 may be separate from the housing 430, e.g., coupled to the active optical amplifier 423 via a cable and/or a network, such as the example operation and maintenance network 454. For example, the controller 452 may turn the local optical pump 432 on or off. Alternatively, or in addition, the controller 452 may activate, deactivate and/or alter an intensity and/or operable wavelength of the local optical pump 432. It is understood that in at least some embodiments, an amplification or gain value of the active optical amplifier 423 may be controlled, at least in part, according to an operational state of the local optical pump 432, e.g., an amplitude and or wavelength. Alternatively, or in addition, the EDFA 404 may be configured as a controllable device, e.g., having multiple gain stages that may be independently controlled to increase, reduce and/or otherwise modify the amplification or gain. Accordingly, the controller 452 may activate, deactivate and/or alter the gain by controlling the configuration of gain stages, e.g., independently activating a greater number of gain stages for an increased gain and/or activating a lesser number of gain stages for a reduced gain.

It is understood that the first and active optical amplifiers 423 may include any of the example optical amplifiers disclosed herein, such as active devices, e.g., SOAs alone and/or in combination with passive devices, e.g., rare earth doped fibers, such as the example EDFA 404. It is further understood that passive devices may be optically excited, stimulated and/or otherwise pumped by optical sources that may be internal and/or external to the housing 430. It is understood that the gain may be applied according to any of the various scenarios disclosed herein.

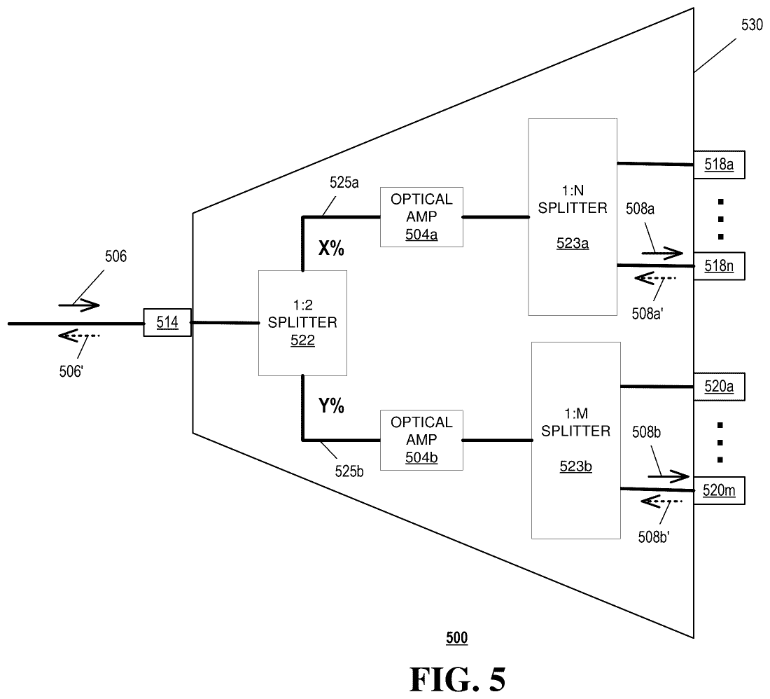

FIG. 5 is a block diagram illustrating an example, non-limiting embodiment of amplified optical power splitter/combiner device 500 functioning within the communication network of FIG. 1 in accordance with various aspects described herein. The example amplified optical power splitter/combiner device 500 includes a housing 530 having at least one upstream housing terminal 514 and a group of downstream housing terminals 518a . . . 518n, generally 518. The upstream housing terminal 514 may be in optical communication with an upstream device, such as the example OLT 210 (FIG. 2). Similarly, the group of downstream housing terminals 518 may be in optical communication with a group of downstream devices, such as the example group of ONTs 212 (FIG. 2). In some embodiments, the amplified optical power splitter/combiner device 500 is configured to operate according to a downstream mode in which a downstream input optical signal 506, e.g., received from an OLT 210 is amplified and divided into multiple downstream optical output signals 508, e.g., directed towards multiple recipients, e.g., the example group of ONTs 212. Alternatively, or in addition, the amplified optical power splitter/combiner device 500 is configured to operate according to an upstream mode in which one or more upstream optical signals 508′, e.g., received from the example group of ONT 212 may be combined into a single upstream optical signals 506′, e.g., directed towards an upstream or headend device, e.g., the example OLT 210.

The example housing 530 includes a first-stage optical signal splitter/combiner 522 adapted to split a downstream optical signal into multiple first-stage divided optical signals. It is understood that in at least some embodiments, the first-stage division may be symmetric, e.g., with the downstream input optical signal 506 divided substantially equally among each of the first-stage divided optical signals. In at least some embodiments, the first-stage division may be asymmetric, e.g., with the downstream input optical signal 506 divided among the different first-stage divided optical signals according to an allocated division percentage and/or a division ratio. According to the illustrative example, the first-stage optical signal splitter combiner 522 operates according to a 1×2 power splitting, in which a first leg 525a of the first-stage divided optical signals corresponds to X % of a total optical power and a second leg 525b of the first-stage divided optical signals corresponds to Y % of the total optical power. The percentages X % and Y % may take on any values, such that a combination of their percentages corresponds to the total optical power.

Further according to the illustrative example, the optical power splitter/combiner 500 has pair of second-stage optical signal splitter/combiners 523a, 523b. An upstream port of one of the second-stage optical signal splitter/combiners 523a is in optical communication with a first output terminal, i.e., the X % terminal, of the first-stage optical signal splitter combiner 522. A first optical signal amplifier 504a provides gain to optical signals existing between the first and second-stage optical signal splitter/combiners 522, 523a. Likewise, an upstream port of another one of the second-stage optical signal splitter/combiners 523b is in optical communication with a second output terminal, i.e., the Y % terminal, of the first-stage optical signal splitter combiner 522. A second optical signal amplifier 504b provides gain to optical signals existing between the first and second-stage optical signal splitter/combiners 522, 523b. It is understood that the first and second optical signal amplifiers 504a, 504b, generally 504, may be similar or different. For example, the optical signal amplifiers 504 may include any of the various example optical amplifiers disclosed herein and/or otherwise generally known. The optical amplifiers 504 may be similar, e.g., both being passive devices and/or active devices. Alternatively, the optical signal amplifiers 504 may be different, e.g., both having different architectures and/or providing different amplification and/or gain values to amplified optical signals.

In some embodiments, the second-stage optical signal splitter/combiners 523a, 523b may be similar, e.g., operating according to identical power splitting/combining ratios, e.g., both being 1×N power splitters/combiners splitting intermediate optical signals according to the different power ratios between the first and second-stage optical signal splitter combiners 522, 523 among equal numbers of optical outputs.

Alternatively, the second-stage optical signal splitter/combiners 523a, 523b may be different, e.g., operating according to identical power splitting/combining ratios, e.g., one of the second-stage optical signal splitter/combiners 523a being 1×N power splitter/combiner, while the other one of the second-stage optical signal splitter/combiners 523a being 1×M power splitter/combiner.

The optical power splitter/combiner 500 has an upstream terminal optically coupled to an upstream terminal of the first-stage optical signal splitter/combiner 522 and a group of downstream terminals in communication with the group of downstream housing terminals 518a, 518b . . . 518n, generally 518. According to the downstream mode of operation, one of the second-stage optical signal splitter/combiner device 523a receives an X % power portion of a downstream input optical signal 506 provided by the first leg 525a of the first-stage divided optical signals and amplifies that signal according to the first optical signal amplifier 504a prior to dividing that signal among the first group of output ports, which provide respective downstream, divided optical output signals 508a to a first group of downstream housing terminals 518. Similarly, the other one of the second-stage optical signal splitter/combiner device 523b receives a Y % power portion of the downstream input optical signal 506 provided by the second leg 525b of the first-stage divided optical signals and amplifies that signal according to the second optical signal amplifier 504b prior to dividing that signal among the second group of output ports, which provide respective downstream, divided optical output signals 508b to a second group of downstream housing terminals 520a . . . 520m, generally 520. It is understood that in at least some embodiments, the optical signal splitter/combiners 522, 523 may operate to combine and amplify upstream optical signals 508a′, 508b′ into a combined or aggregate upstream optical signal 506′.

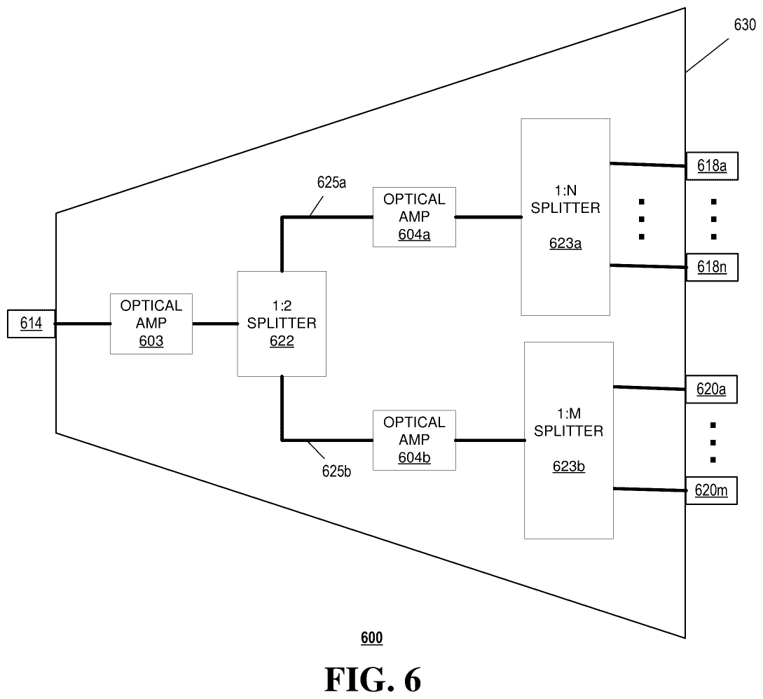

FIG. 6 is a block diagram illustrating an example, non-limiting embodiment of another amplified optical power splitter/combiner device 600 functioning within the communication network of FIG. 1 in accordance with various aspects described herein. The example amplified optical power splitter/combiner device 600 includes a housing 630 having an upstream housing terminal 614, a first group of downstream housing terminals 618a . . . 618n, generally 608 and a second group of downstream housing terminals 620a . . . 620m, generally 620. The housing 630 includes a multi-stage optical power splitting/combining configuration, which includes at least one first-stage optical signal splitter/combiner 622 and at least one second-stage optical power splitter combiner having at least one second-stage optical splitter/combiner 623a and at least one other second-stage optical signal splitter/combiner 623b. The at least one second-stage optical splitter combiner 623a is in optical communication with a first leg 625a of the first-stage divided optical signal. Likewise, the at least one other second-stage optical splitter/combiner 623b is in optical communication with a second leg 625b of the first-stage divided optical signal. A first group of output terminals of the at least one second-stage optical splitter/combiner 623a are in communication with the first group of downstream housing terminals 618 and a second group of output terminals of the at least one other second-stage optical signal splitter/combiner 623b are in communication with the second group of downstream housing terminals 620.

In at least some embodiments, the amplified optical power splitter/combiner device 600 may include multi-stage optical amplification. According to the illustrative example, a first-stage optical amplifier 603 is coupled between the upstream housing terminal 614 and a downstream terminal of the first-stage optical signal splitter/combiner 622 and configured to provide a first stage of optical signal gain G₁. Similarly, one second-stage optical amplifier 604a is coupled within the first leg 625a to provide a second stage of optical signal gain G₂ₐₗ between the first-stage optical signal splitter/combiner 622 and one of the second-stage optical signal splitter/combiners 623a. Likewise, another second-stage optical amplifier 604b is coupled within the second leg 625b to provide another second stage of optical signal gain G₂ₐ between the first-stage optical signal splitter/combiner 622 and the other one of the second-stage optical signal splitter/combiners 623b.

The optical signal gain values G₁, G₂ₐ, G_{2b} may be selected and/or otherwise applied according to a predetermined operational scenario. In at least some embodiments, the optical signal gain values G₁, G₂ₐ, G_{2b} are selected to provide a gain-compensated signal division/combination. Namely, the gain applied to a downstream signal provides optical powers of optical output signals that are comparable to an optical signal power of an optical signal at the intermediate gain stage, e.g., in the first and/or second legs 625a, 625b and/or that are comparable to an optical signal power to a downstream signal received by the amplified optical power splitter/combiner device 600. For example, the optical signal gain values G₁, G₂ₐ, G_{2b} may be determined, selected and/or otherwise managed to effectively overcome at least a portion of what would otherwise be insertion loss of the amplified optical power splitter/combiner device 600, e.g., signal loss attributable to power division of the signal. In at least some embodiments, the optical signal gain values G₁, G₂ₐ, G_{2b} may be determined, selected and/or otherwise managed to compensate for and/or effectively overcome the insertion loss of the amplified optical power splitter/combiner device 600, e.g., signal loss attributable to power division of the signal.

It is envisioned that in at least some embodiments, one or more of the signal gain values G₁, G₂ₐ, G_{2b} may be adjusted via a feedback control signal. For example, a small sample of the optical signal power levels may be obtained, e.g., using an optical coupler. Accordingly, one or more sampled optical signal power levels may be measured and compared, e.g., to a threshold optical signal power level, a preferred optical signal power range and/or a predetermined optical signal power level. A comparison result may be obtained, such that an amplifier control signal, e.g., an error signal, may be determined based on the comparison result. The amplifier control signal may be applied, as appropriate, to one or more of the first and second-stage optical amplifiers 603, 604a, 604b to adjust the corresponding signal gain values in order to reduce the error value, causing the amplified optical power splitter/combiner device 600 to provide a predetermined amount of gain compensation to downstream signals, upstream signals and/or combinations of both downstream and upstream signals. It is envisioned that in at least some embodiments, the amplified optical power splitter/combiner device 600 may include one or more gain controllers (not shown) configured to provide amplifier control signals according to the example feedback loops.

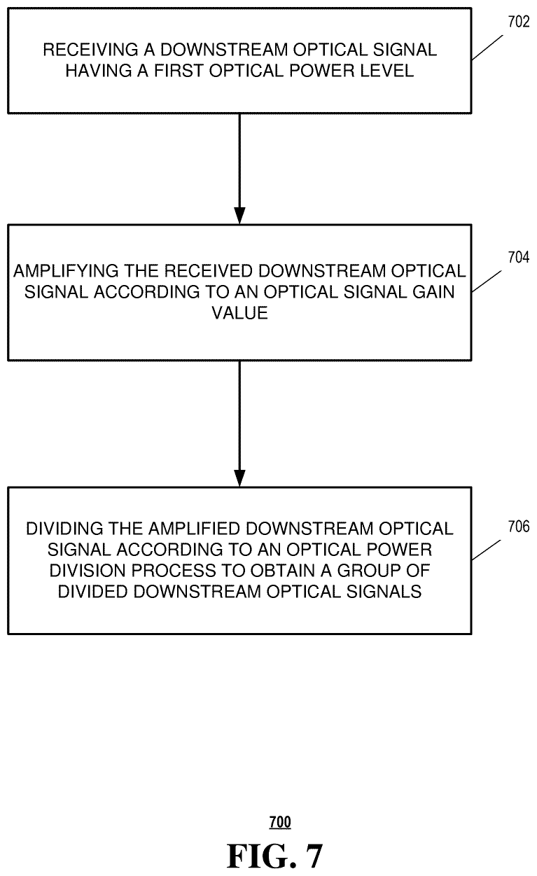

FIG. 7 depicts an illustrative embodiment of a gain-compensated optical signal distribution process 700 in accordance with various aspects described herein. The example process 700 includes receiving a downstream optical signal, at 702, having a first optical power level. The example process 700 further includes amplifying the received downstream optical signal, at 704, according to an optical signal gain value. Further according to the example process 700, the amplified downstream optical signal is divided according to an optical power division process to obtain a group of divided downstream optical signals at 706 operating according to optical power divided signal levels. In at least some embodiments, the optical signal gain value is selected to obtain a desired relationship between the first optical power level and the optical power divided signal levels. For example, the desired relationship may include a ratio of the first optical power level and the optical power divided signal levels that does not necessarily depend upon the power division process. For example, the desired relationship may include that the optical power divided signal levels are comparable to the first optical power level.

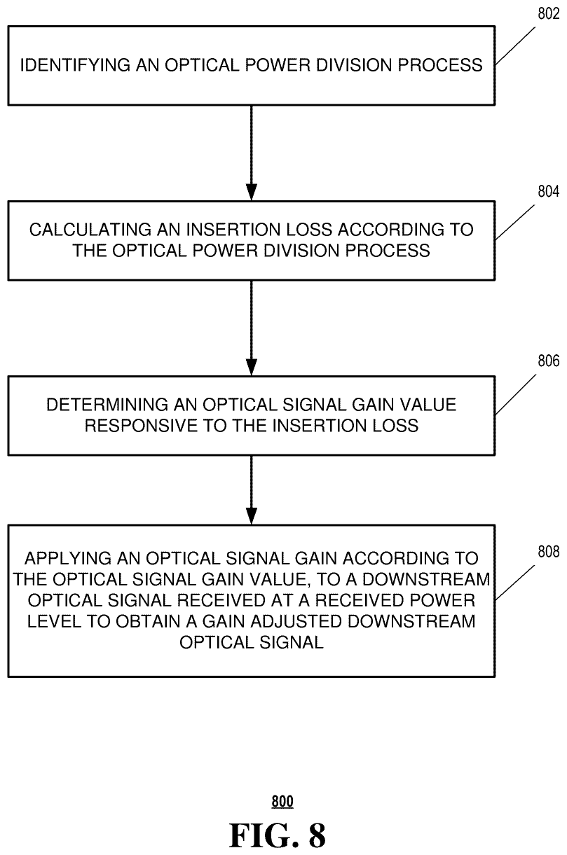

FIG. 8 depicts an illustrative embodiment of another gain-compensated optical signal distribution process 800 in accordance with various aspects described herein. The example gain-compensated optical signal distribution process 800 includes identifying an optical power division process at 802. Further according to the example process 800, an insertion loss is calculated, at 804, according to the optical power division process. An optical signal gain value is determined, at 806, responsive to the insertion loss. Further according to the example process, the optical signal gain, according to the optical signal gain value, is applied, at 808, to a downstream optical signal received at a received power level to obtain a gain adjusted downstream optical signal at 808. In at least some embodiments, the optical signal gain value is determined to obtain a desired relationship between a first optical power level and second optical power divided signal levels such that the optical power divided signal levels are comparable to the first optical power level.

While for purposes of simplicity of explanation, the respective processes are shown and described as a series of blocks in FIGS. 7 and 8 it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

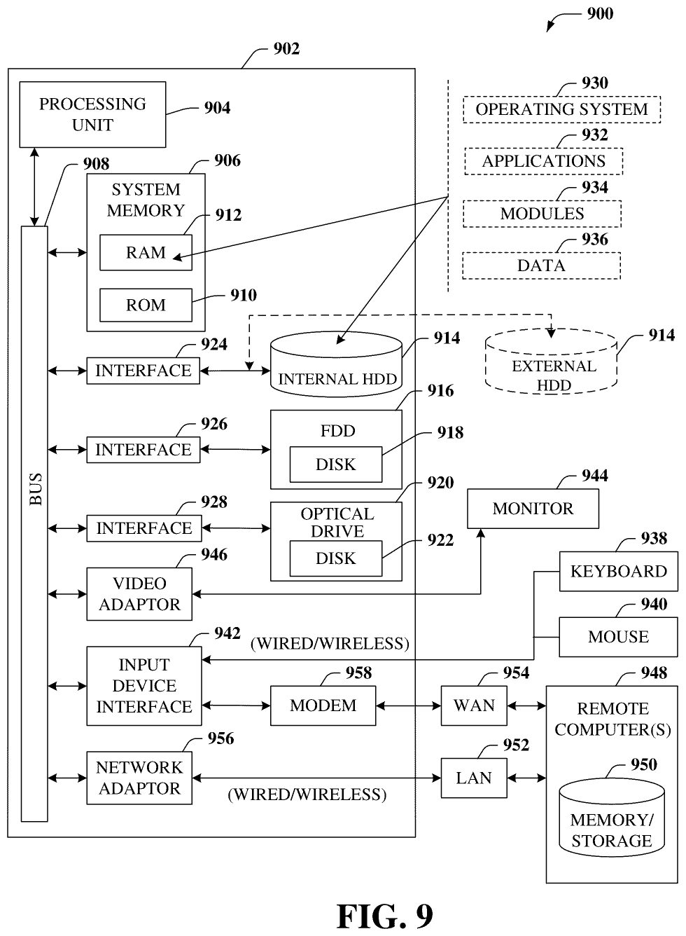

With reference again to FIG. 9, the example environment 900 can comprise a computer 902, the computer 902 comprising a processing unit 904, a system memory 906 and a system bus 908. The system bus 908 couples system components including, but not limited to, the system memory 906 to the processing unit 904. The processing unit 904 can be any of various commercially available processors. Dual microprocessors and other multiprocessor architectures can also be employed as the processing unit 904. It is envisioned that the computer 902 may be configured according to any of the example control devices disclosed herein, such as an amplifier gain controller, an optical signal gain feedback controller, a controller adapted to implement one or more rules and/or policies as may be utilized in operation of any of the example systems and/or devices disclosed herein, such as determining signal splitting configurations, e.g., ratios of optical signal splitters and/or combiners, numbers of optical signal splitters and/or combiners, staging, whether single stage and/or multi-stage of optical signal division, determination of and/or implementation of optical amplifier gain values, and so on.

The system bus 908 can be any of several types of bus structure that can further interconnect to a memory bus (with or without a memory controller), a peripheral bus, and a local bus using any of a variety of commercially available bus architectures. The system memory 906 comprises ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also comprise a high-speed RAM such as static RAM for caching data.

The computer 902 further comprises an internal hard disk drive (HDD) 914 (e.g., EIDE, SATA), which internal HDD 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high-capacity optical media such as the DVD). The HDD 914, magnetic FDD 916 and optical disk drive 920 can be connected to the system bus 908 by a hard disk drive interface 924, a magnetic disk drive interface 926 and an optical drive interface 928, respectively. The hard disk drive interface 924 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 912, comprising an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

A user can enter commands and information into the computer 902 through one or more wired/wireless input devices, e.g., a keyboard 938 and a pointing device, such as a mouse 940. Other input devices (not shown) can comprise a microphone, an infrared (IR) remote control, a joystick, a game pad, a stylus pen, touch screen or the like. These and other input devices are often connected to the processing unit 904 through an input device interface 942 that can be coupled to the system bus 908, but can be connected by other interfaces, such as a parallel port, an IEEE 1394 serial port, a game port, a universal serial bus (USB) port, an IR interface, etc.

A monitor 944 or other type of display device can be also connected to the system bus 908 via an interface, such as a video adapter 946. It will also be appreciated that in alternative embodiments, a monitor 944 can also be any display device (e.g., another computer having a display, a smart phone, a tablet computer, etc.) for receiving display information associated with computer 902 via any communication means, including via the Internet and cloud-based networks. In addition to the monitor 944, a computer typically comprises other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically comprises many or all of the elements described relative to the computer 902, although, for purposes of brevity, only a remote memory/storage device 950 is illustrated. The logical connections depicted comprise wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the LAN 952 through a wired and/or wireless communication network interface or adapter 956. The adapter 956 can facilitate wired or wireless communication to the LAN 952, which can also comprise a wireless AP disposed thereon for communicating with the adapter 956.

When used in a WAN networking environment, the computer 902 can comprise a modem 958 or can be connected to a communications server on the WAN 954 or has other means for establishing communications over the WAN 954, such as by way of the Internet. The modem 958, which can be internal or external and a wired or wireless device, can be connected to the system bus 908 via the input device interface 942. In a networked environment, program modules depicted relative to the computer 902 or portions thereof, can be stored in the remote memory/storage device 950. It will be appreciated that the network connections shown are example and other means of establishing a communications link between the computers can be used.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches, and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature, or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. An optical signal distribution device, comprising:
an optical amplifier configured to apply an optical signal gain adapted to amplify a downstream optical signal operating at a first optical power level according to the optical signal gain to obtain an amplified downstream signal at a second, increased optical power level; and
an optical power divider comprising a first optical port and a plurality of second optical ports, wherein the first optical port is optically coupled to the optical amplifier, wherein the optical power divider is configured to apply a power division the amplified downstream signal to obtain a plurality of divided optical signals provided to the plurality of second optical ports, wherein resulting optical signal levels of the plurality of divided optical signals are reduced from the second, increased optical power level according to the power division.

2. The optical signal distribution device of claim 1, wherein the optical signal gain is adapted to offset the power division.

3. The optical signal distribution device of claim 2, wherein the optical signal gain is adapted to substantially compensate for the power division, such that at least one of the plurality of divided optical signals provided to the plurality of second optical ports comprises an output signal power level that approximates the first optical power level.

4. The optical signal distribution device of claim 1, further comprising a housing, wherein the housing contains the optical amplifier and the optical power divider.

5. The optical signal distribution device of claim 4, wherein the optical amplifier and the optical power divider are passive devices adapted to facilitate operation of the optical signal distribution device within a passive optical network (PON).

6. The optical signal distribution device of claim 1, wherein the optical amplifier comprises a rare-earth doped optical waveguide.

7. The optical signal distribution device of claim 6, wherein the rare-earth doped optical waveguide further comprises an Erbium-doped optical waveguide.

8. The optical signal distribution device of claim 6, wherein the optical amplifier receives an optical pumping input, the optical signal gain determined at least in part upon an optical power level of the optical pumping input.

9. The optical signal distribution device of claim 8, wherein the optical pumping input comprises an optical pump signal co-propagating with the downstream optical signal.

10. The optical signal distribution device of claim 1, wherein the optical power divider is configured to apply a non-uniform power division, wherein resulting optical signal levels of the plurality of divided optical signals comprise respectively different optical signal levels according to the non-uniform power division.

11. The optical signal distribution device of claim 1, further comprising a controller in communication with the optical amplifier, wherein the controller provides a control signal, and wherein the optical signal gain is determined at least in part according to the control signal.

12. An optical signal distribution method, comprising:
receiving a downstream optical signal to obtain a received downstream optical signal having a first optical power level;
amplifying the received downstream optical signal according to an optical signal gain value to obtain an amplified downstream optical signal; and
dividing the amplified downstream optical signal according to an optical power division process to obtain a plurality of divided downstream optical signals, wherein the plurality of divided downstream optical signals operate according to a plurality of second optical power levels determined at least in part according to the optical power division process.

13. The optical signal distribution method of claim 12, wherein the optical signal gain value is adapted to offset at least a portion of a power loss resulting from the optical power division process.

14. The optical signal distribution method of claim 13, wherein the optical signal gain value is adapted to substantially compensate for the optical power division process, such that at least one of the plurality of divided downstream optical signals comprises an output signal power level that approximates the first optical power level.

15. The optical signal distribution method of claim 12, wherein the receiving the downstream optical signal comprising receiving the downstream optical signal at a downstream terminal of a housing comprising optical signal processing equipment configured to perform the amplifying of the received downstream optical signal and the dividing of the amplified downstream optical signal.

16. The optical signal distribution method of claim 15, wherein the optical signal processing equipment operates within a passive optical network (PON) without requiring electrical power.

17. The optical signal distribution method of claim 12, wherein the amplifying the received downstream optical signal further comprises:
optically pumping a rare-earth doped optical waveguide to obtain an optically pumped optical waveguide; and
exposing the received downstream optical signal to the optically pumped optical waveguide, wherein the optical signal gain value is determined at least in part according to the exposing of the received downstream optical signal to the optically pumped optical waveguide.

18. The optical signal distribution method of claim 12, wherein the dividing the amplified downstream optical signal according to the optical power division process further comprises applying non-uniform power division process resulting optical signal levels of the plurality of divided downstream optical signals comprising respectively different optical signal levels according to the non-uniform power division process.

19. The optical signal distribution method of claim 12, further comprising:
determining a control signal according to the optical power division process, wherein the optical signal gain value is based on the control signal; and
adjusting, responsive to the control signal, the amplifying the received downstream optical signal to obtain the amplified downstream optical signal.

20. A non-transitory machine-readable medium, comprising executable instructions that, when executed by a processing system including a processor, facilitate performance of operations, the operations comprising:
identifying an optical power division process;
calculating an insertion loss according to the optical power division process;
determining an optical signal gain value responsive to the insertion loss; and
applying an optical signal gain according to the optical signal gain value, to a downstream optical signal received at a received power level to obtain a gain adjusted downstream optical signal, wherein a division of the gain adjusted downstream optical signal yields a divided optical signal having an output optical power level approximating the received power level.
